(19) United States
(12) Patent Application Publication
(10) Pub. No.: US 2026/0284879 A1
(43) Pub. Date: Sep. 24, 2026

(54) Controlling Stability of Mobile Manipulators by External Stabilizing Devices

(71) Applicant: ABB Schweiz AG, Baden (CH)

(72) Inventors: Arne-Christoph Hildebrandt, München (DE); Jonas Larsson, Västerås (SE); Christoph Bick, Augsburg (DE)

(73) Assignee: ABB Schweiz AG, Baden (CH)

(21) Appl. No.: 19/670,153

(22) Filed: May 7, 2026

Related U.S. Application Data
(63) Continuation of application No. PCT/EP2023/081091, filed on Nov. 8, 2023.

(51) Int. Cl. B25J 9/16; B25J 5/00; B25J 19/00

(52) U.S. Cl. CPC B25J 9/1664; B25J 5/007; B25J 9/162; B25J 19/0008

(57) ABSTRACT

A method for controlling a mobile manipulator includes determining a current configuration of the mobile manipulator, determining a desired movement trajectory of the mobile manipulator, determining a current zero-movement points (ZMP) trajectory comprising the location of one or more current ZMP of the mobile manipulator, determining a desired ZMP trajectory of the mobile manipulator, wherein each ZMP is located within a support polygon of the manipulator base, and adjusting the mobile manipulator such that the current ZMP trajectory corresponds to the desired ZMP trajectory, wherein the mobile manipulator further comprises at least one external stabilizing device and wherein the step of adjusting the mobile manipulator comprises the step of supporting of the mobile manipulator by the external stabilizing device.

### CROSS-REFERENCE TO RELATED APPLICATIONS

The instant application claims priority to International Patent Application No. PCT/EP2023/081091, filed Nov. 8, 2023, which is incorporated herein in its entirety by reference.

### FIELD OF THE DISCLOSURE

The present disclosure generally relates to a method for controlling a mobile manipulator, a mobile manipulator, a computer program product, and a computer-readable medium.

### BACKGROUND OF THE INVENTION

In recent years, automation industry is focusing more and more on automating applications in life science and pharmaceutical areas. These applications often consist of combinations of transportation tasks in laboratory environments and pick & place tasks on different workplaces. A robot type, which is proposed to answer these needs, is the mobile manipulator. It combines a mobile base with an attached manipulator. Due to limited space in laboratory environments, the requirements on the size of these robots are increasing. Especially the footprint size of the robot is in the focus for optimization. Common manipulators often comprise a heavy and large base, which may be disadvantageous when the robots should operate in constrained spaces. In addition to the size of the robot, the overall time the robot needs to execute tasks has to be constantly decreased. This need leads to higher acceleration of the mobile base while navigating and while executing pick and place tasks. A challenge that arises from these requirements is to ensure that the robot stays stable and, for instance, does not tip over. Problems at the stability may occur with higher dynamic forces which therefore increases the challenge to ensure the stability of the robot.

Thus, there is a need for sophisticated approaches to prevent an instability of a mobile manipulator.

### BRIEF SUMMARY OF THE INVENTION

The present invention relates to a method for controlling a mobile manipulator comprising a manipulator base and at least one manipulator arm. The method includes determining a current configuration of the mobile manipulator including a manipulator arm configuration and a manipulator base configuration, determining a desired movement trajectory of the mobile manipulator, determining a current zero-movement points (ZMP) trajectory, comprising the location of one or more current ZMP of the mobile manipulator, based on the current configuration of the mobile manipulator and the desired movement trajectory, determining a desired ZMP trajectory of the mobile manipulator, wherein each ZMP is located within a support polygon of the manipulator base, and adjusting the mobile manipulator such that the current ZMP trajectory corresponds to the desired ZMP trajectory.

In one embodiment, the mobile manipulator further comprises at least one external stabilizing device and the step of adjusting the mobile manipulator comprises the step of supporting of the mobile manipulator by the external stabilizing device.

Accordingly, a flexible method for stabilizing mobile manipulators using an external stabilization device, which ensures that the mobile manipulator may stay stable and does not tip-over, may be provided. The control of the external standardizing device may be performed by respective control means of the mobile manipulator. The control means may comprise respective computing means adapted to control a movement of the external stabilizing device based on respective input parameters such that on that the current ZMP trajectory may correspond to the desired ZMP trajectory. The manipulator arm may, for instance, be able to reach out as far as possible to have a maximum working range. Depending on the weight of the manipulator arm and/or the weight of an object arranged at a tool center point, TCP, at the distal end of the manipulator arm and its motions, the mobile manipulator may become instable and may accordingly tip over. In such a condition, the current ZMP trajectory of the mobile manipulator lies outside the support polygon. The control method of the present invention may be particularly useful for stabilizing mobile manipulators performing a stationary pick and place task.

### BRIEF DESCRIPTION OF THE SEVERAL VIEWS OF THE DRAWING(S)

For a better understanding of the present invention, and to illustrate its practicality, figures are provided in the following and reference is made thereto. It should be understood that the figures represent only exemplary embodiments and thus in no way limit the scope of the claimed invention. Identical or like-acting elements are indicated throughout by the same reference signs. Any reference signs in the claims should not be construed as limiting the scope of the claims.

In the accompanying drawings,

FIG. 1 schematically illustrates a mobile manipulator according to one embodiment of the present invention;

FIGS. 2A and 2B schematically illustrate a mobile manipulator according to one embodiment of the present invention in different configurations; and

FIG. 3 is a flowchart illustrating a method for controlling a mobile manipulator according to the present invention.

### DETAILED DESCRIPTION OF THE INVENTION

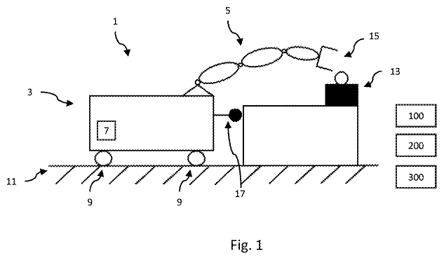

FIG. 1 depicts a mobile manipulator 1 according to the present invention. The mobile manipulator 1 comprises a manipulator base 3 and a manipulator arm 5 attached at the top side of mobile base 3. It will be understood that in different embodiments, also more than one manipulator arm 5 may be provided and that the position of the one or more manipulator arms 5 may vary, e.g. the manipulator arm 5 may be provided at the front or back side or at a lateral side of the of the mobile manipulator 1. The mobile manipulator arm 5 is formed as a movable arm comprising multiple arm elements which are linked together to allow a flexible movement and an extension or retraction of the arm. However, it will be understood that in different environments also a stiff manipulator arm may be provided consisting, for instance, only of a single stiff arm element movably attached to the manipulator base 3. The manipulator arm 5 is hinged at a proximal end of the manipulator arm 5 with the mobile phase 3 and comprises a TCP 15 at the distal end of the manipulator arm 5. In the depicted embodiment, the TCP 15 is formed as a gripper to allow a grip and lift of an external mass element or load 13. The manipulator base 3 comprises contact elements 9 in form of wheels to contact the floor 11. Thus, the mobile manipulator 1 may be moved along the floor 11 along a predefined movement trajectory. The mobile manipulator 1 further comprises an external stabilizing device in form of a telescopic arm 17. In the depicted configuration, the telescopic arm 17 extends from the front side of the manipulator base 3 and contacts a wall of a support platform, upon which the mass element 13 is arranged. Accordingly, when the mobile manipulator arm 5 picks up the mass element 13, the mobile manipulator 1 is stabilized by the telescopic arm 17 and therefore does not tip over. The orientations of the manipulator arm 5 and/or the telescopic arm 17 may be set and controlled by the control means 7 of the mobile manipulator 1. In the depicted embodiment, the control means 7 is arranged at the mobile manipulator 1. However, it will be understood that in different embodiments, the control means 7 can also be arranged at least partially outside of or remote to the mobile manipulator 1. The control means 7 may comprise suitable sensing, computing and controlling means for controlling the elements of the mobile manipulator 1. This may include, for instance, the control of an orientation of the manipulator arm 5 and/or the telescopic arm 17 or a propelling speed, acceleration and direction of movement of the wheels. Depending on the configuration of the manipulator arm 5 and/or the telescopic arm 17, the center of mass of the mobile manipulator 1 changes. For instance, in the depicted embodiment, due to the manipulator arm configuration, the center of mass of the mobile manipulator 1 is shifted to the right because the manipulator arm 5 extends beyond and away from the manipulator base 3. As noted above, this can be counteracted by the contact of the telescopic arm 17, which accordingly increases the support surface of the mobile manipulator 1.

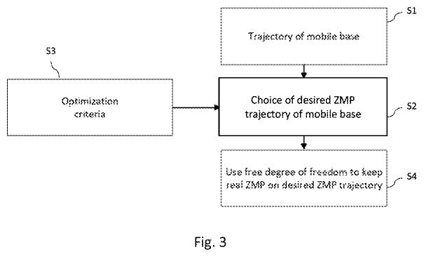

Further, a computer-program product 200 and a computer-readable medium 300 are shown, each comprising instructions, which, when executed by a computer 100, cause the computer 100 to carry out and/or control the method of any embodiments of the present invention, in particular the method as illustrated in FIG. 3. In the depicted embodiment, the computer 100, the computer-program product 200 and the computer-readable medium 300 are depicted as external elements. However, it will be understood that in different embodiments, any of the computer 100, the computer-program product 200 and the computer-readable medium 300 may be at least partly integrated in the mobile manipulator 1.

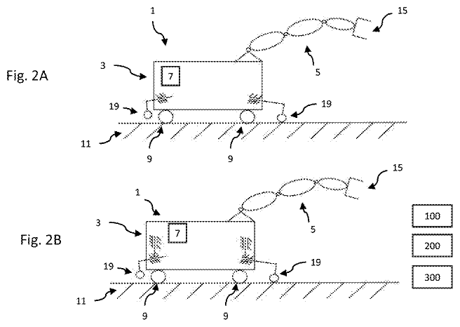

FIGS. 2A and 2B depict a different embodiment of the mobile manipulator 1. In this embodiment, the same elements of the mobile manipulator 1 as described for the embodiment of FIG. 1 are provided and it is accordingly referred thereto, with the difference that, instead of the telescopic arm 17, additional support wheels 19 are provided. When the mobile manipulator 1 becomes unstable, for instance due to a shift of the center of mass caused by a respective extension of the manipulator arm 5 to the right beyond the manipulator base 3, the support wheels 19 may be activated. Thus, the support polygon of the mobile manipulator 1 could be increased and the mobile manipulator one could be accordingly stabilized. In FIG. 2A, the support wheels 19 comprise one degree of freedom, namely the extension of the wheels away from the manipulator base 3. Thus, a respective distance of the support wheels 19 to the mobile manipulator 1 can be defined. In FIG. 2B, the support wheels 19 comprise two degrees of freedom, namely the extension of the wheels away from the manipulator base 3 and a height of the support wheels 19 with respect to the ground 11. Thus, the support wheels 19 may be accordingly adjusted in two dimensions.

FIG. 3 depicts a flowchart illustrating a method for controlling a mobile manipulator 1 according to an embodiment of the present invention. In step S1 of the depicted embodiment, a desired movement trajectory of the mobile base 3 or the mobile manipulator 1 is determined. In step S2 of the depicted embodiment, based on the desired movement trajectory, the desired ZMP trajectory of the mobile base 3 or the mobile manipulator 1 is chosen or determined. As shown in step S3, optimization criteria may be introduced to improve the overall performance of the mobile manipulator 1. Such optimization criteria may be any suitable criteria for optimizing a mobile manipulator action such as, for instance, the requirement to employ the lowest possible acceleration or the highest possible speed or to reduce the power consumption of the mobile manipulator 1. In step S4 the ZMP trajectory is used as an input for the definition of the motion of the mobile manipulator 1 to exploit the redundant degrees of freedom. The free degrees of freedom can be accordingly used to keep the current ZMP trajectory of the mobile manipulator 1 on the desired ZMP trajectory of the mobile manipulator 1.

In the context of the present disclosure, the mobile manipulator may be any kind of movable robot. “Mobile” or “movable” manipulators in this context may be understood such that the manipulator may assume different positions or locations on the ground. The position of the mobile manipulator may be accordingly changed. For instance, the mobile manipulator may move itself or is moved by respective means from a starting point to an end point via a predetermined distinct travel path.

The manipulator arm may be any type of mechanical arm. The manipulator arm may comprise multiple elements linked with each other and the mobile base to form a kinematic chain. The links of such a manipulator arm may be connected by respective joints allowing, for instance, a rotational motion or a linear translational displacement. However, it will be understood that the manipulator arm may also comprise only one stiff element linked to the manipulator base. The manipulator arm may be programmable for allowing execution of respective movements for performing different tasks. Also, more than one manipulator arm may be provided.

An external stabilizing device may be an element, which may allow the size of the support polygon to increase by making contact with the environment of the mobile manipulator. The external stabilizing device may comprise multiple elements linked with each other and the mobile base to form a kinematic chain. The external stabilizing device may be in form of a telescopic arm attached to the mobile manipulator. The links of the external stabilizing device may be connected by respective joints allowing for instance a rotational motion or a linear translational displacement. However, it will be understood that the external stabilizing device may also comprise only one stiff element linked to the manipulator base. The external stabilizing device may be programmable for allowing execution of respective movements. Also, more than one external stabilizing device may be provided.

The manipulator base may essentially define the core body of the mobile manipulator, at which the manipulator arm and/or the external stabilizing device may be attached. The manipulator base may house respective propelling or controlling means such as the power supply, one or more motors and/or computing devices, which may be enclosed by a housing to protect the mobile manipulator elements arranged inside from negative impacts, such as dust and moisture. The manipulator base may define the support polygon, which may be extended by the external stabilizing device. The support polygon may be a surface area upon which the mobile manipulator is supported or carried on the ground. The support polygon may comprise three, four or more edges or may have a circular, oval or of any other two-dimensional shape.

The current configuration of the mobile manipulator may include information about the extension and/or the weight of the respective parts of the mobile manipulator. For instance, the current configuration may include information about a center of mass of each component and/or the whole mobile manipulator. The center of mass of the mobile manipulator may comprise the masses and dimensions of the whole mobile manipulator or may only comprise masses and dimensions of individual parts. This may be, for instance, the largest parts or parts, which have the largest impact on the position of the center of mass of the mobile manipulator.

The manipulator arm configuration may include an extension or orientation of the manipulator arm with respect to the manipulator base, e.g., an angle of rotation or an extension of the manipulator arm and information about the weight or item the manipulator arm carries. The manipulator base configuration may include information about the manipulator bases' weight or the dimensions of the manipulator base, such as, for instance, the dimension of a lower base surface of the manipulator base, which may form the support polygon. Any suitable parameter concerning the center of mass of the mobile manipulator may be included.

The location at which the manipulator arm and/or the external stabilizing device is attached to the manipulator base may be fixed or may vary. The manipulator arm and/or the external stabilizing device may be provided at any desired side of the manipulator base, for instance at a top side, a front or back side, or at one of the lateral sides of the mobile manipulator. The manipulator arm configuration may include a distinct position and/or orientation of the manipulator arm in space, such as an arm stance. The manipulator arm configuration may comprise an information about the rotational position of the manipulator arm or an extension of the manipulator arm, e.g., an extension beyond the manipulator base. The manipulator base configuration may accordingly comprise a spatial extension and a weight or weight distribution of the manipulator base.

The desired movement trajectory may be a trajectory or path the mobile manipulator may take on a ground. Thus, the desired movement trajectory may be provided in an essentially horizontal two-dimensional plane. The mobile manipulator may move on the ground along the desired movement trajectory from a start position to an intermediate or end-position. The desired movement trajectory may be based on one or more tasks the mobile manipulator should perform, e.g. to pick up in item at a first position and to place said item at a second position. Or the desired movement trajectory may be based on movement of the manipulator arm performing a certain task to pick up an item at a first position and to place said item in the same position. The movement trajectory may comprise one or more straight movements or curved movements, or any other arbitrary geometrical movement, for instance a movement on the ground between the start position and the end-position. The desired movement trajectory may comprise intermediate positions, at which the mobile manipulator may change its direction of motion. For instance, the mobile manipulator may pick up an item at a start position and move along the desired movement trajectory towards an end position to drop said item at this end position. The mobile manipulator may accordingly continue to a third point with or without picking up the same or a different item and/or may return to its starting position.

A ZMP may be understood as a point at which reaction forces of a contact between mobile manipulator and the ground do not produce any moment in the horizontal direction, i.e., in a direction of a plane in which the mobile manipulator moves. This may be a direction in a plane essentially perpendicular to a direction of gravity. In a common notation, a plane in which the mobile manipulator moves may extend in a x-y-direction and the direction of gravity is in a z-direction. The ZMP may be considered as the point where the sum of horizontal moments Mx, and My is zero. In other words, the ZMP may be defined as the reference point in the contact plane between robot and ground, for which the horizontal components of the contact moment vanish. The ZMP of the mobile manipulator may depend on the manipulator arm configuration, the manipulator base configuration, e.g. the extension of the support polygon, and the desired movement trajectory. One or more ZMP may be determined or predicted for the mobile manipulator. A determination may also be understood as a prediction in the current disclosure. Any ZMP may depend on a configuration of the mobile base and the manipulator arm including, for instance, a weight and spatial extension of said components and their respective arrangement with respect to each other.

Based on the current configuration of the mobile manipulator, a current ZMP trajectory may be determined or predicted. The current ZMP trajectory may correspond to one or more predicted ZMP locations of the mobile manipulator when the mobile manipulator would move along the desired movement trajectory. The mobile manipulator may be considered stable when its predicted current ZMP are located within the support polygon. If the one or more predicted current ZMP of the mobile manipulator is arranged in the support polygon, the mobile manipulator may be stable such that no tipping over may occur during the movement along the desired movement trajectory. Thus, in the method of the present invention, the mobile manipulator may be preferably configured such that its ZMP are located in the support polygon, thus allowing for a stable movement or standstill.

Accordingly, knowing the desired movement trajectory of the mobile manipulator and considering the mobile manipulators' configuration, e.g., based on the arm configuration, a desired ZMP trajectory may be determined or predicted, which may allow for a stable movement of the mobile manipulator when moving along the desired movement trajectory or a stable reaching out of the manipulator arm and picking and placing of a weight. If the mobile manipulator would move along the desired movement trajectory, and its ZMP correspond or are sufficiently close to the desired ZMP trajectory, stable movement of the mobile manipulator may be achieved.

Thus, the mobile manipulator may be accordingly adjusted such that the current ZMP trajectory may correspond or may be close to the desired ZMP trajectory to achieve a stable movement of the mobile manipulator. This adjustment may be performed before or during the movement of the mobile manipulator. For different sections of the movement trajectory, different adjustments of the mobile manipulator may be provided to obtain stable configuration. The adjustment may be similarly performed when the mobile manipulator is standing still and moving just the manipulator arm. For instance, if a ZMP would lie outside or is too far away from the desired ZMP trajectory, a mobile manipulator might accordingly become unstable during movement of the manipulator base and/or manipulator arm.

In the approach of the present invention, a control strategy based on the ZMP criteria could be formulated. The desired ZMP trajectory may be based on the current motions of the mobile base. The desired ZMP trajectory may be required to respect the ZMP criteria and may have to lie inside the support polygon. Its exact location inside the polygon may not be restricted and may be used to optimize further criteria, for instance regarding energy optimality. Using the desired ZMP trajectory as reference trajectory, a control problem according to the present invention may be set up. Thus, a control function f may be used to minimize the deviation of the real or current ZMP trajectory from the desired ZMP trajectory. This approach may allow for suitably supporting the mobile manipulator by a respective control of an external stabilizing device.

In a preferred embodiment, the manipulator base comprises one or more contact elements configured to contact a ground upon which the mobile manipulator is movable, wherein the contact elements are preferably formed by wheels.

Thus, a stable stand on the ground of the manipulator base during movement or standstill of the mobile manipulator may be achieved. Providing wheels may allow the mobile manipulator to be easily steered along the ground in one or more desired directions. One or more of the wheels may be actively steerable by respective controls and propelling means of the mobile manipulator or may rotate passively. The present invention is not limited to wheels but may also comprise any type of steerable or non-steerable element that may allow a movement of the mobile manipulator on the ground.

In a preferred embodiment, the manipulator base comprises at least three contact elements, wherein the support polygon is defined by an area formed between the contact elements and, wherein, when the mobile manipulator is stabilized by the external stabilizing device, the support polygon is additionally defined by a contact point of the external stabilizing device, wherein the ZMP are adjusted to be located within the support polygon of the mobile manipulator.

The support polygon may be accordingly defined by an area spanned between the contact elements contacting the ground and, when the mobile manipulator is stabilized by the external stabilizing device, also by the contact point of the external stabilizing device. The contact point may be the point at which the external stabilizing device contacts one or more supporting surfaces in the environment of the mobile manipulator, e.g., a table, a wall, or any other support element. This contact may accordingly stabilize the mobile manipulator. Accordingly, to achieve a stable condition of the mobile manipulator, the support polygon may be enlarged compared to the condition without the use of the external stabilizing device. The ZMP may be accordingly adjusted to be located in the support polygon to allow a stable movement or stand of the mobile manipulator during operation.

In a preferred embodiment, the external stabilizing device comprises at least one telescopic support arm, which can be activated or deactivated based on the following steps: determining the ZMP of the mobile manipulator during movement of the manipulator arm, deactivating the telescopic support arm when the ZMP of the mobile manipulator is determined to be located in the support polygon, and activating the telescopic support arm when the ZMP of the mobile manipulator is determined to be located outside of the support polygon.

Thus, a flexible support method for the mobile manipulator may be provided, which may allow for a stabilization of the mobile manipulator on demand. An activation or deactivation may include an expansion or retraction of the telescopic support arm. The telescopic support arm may comprise a plurality of interconnected telescopic support arm elements, which may be moved with respect to each other in a telescopic arm like manner. The movement of the telescopic support arm elements may thus be essentially along an extension axis. The telescopic arm may be hinged at a proximal side to the manipulator base and may provide a contact with an environmental support surface at a distal side. The extension and movement of the telescopic support arm may be accordingly determined by respective sensor means and control means of the mobile manipulator, including respective motors for activating and/or deactivating the telescopic support arm.

In a preferred embodiment, the external stabilizing device comprises at least one support wheel, wherein the support wheel, which can be activated or deactivated, wherein the support wheel, when activated, contacts the ground and increases the support polygon of the mobile manipulator.

Thus, an additional or alternative option for stabilization may be provided. The support wheel may be similar to the propelling or driving wheels, which may move the mobile over the ground. However, the support wheel may also be configured in a completely different manner. The support wheel may be actively steered or may be passively rotatable. The support wheel may be linked to the mobile manipulator base via a support wheel axle. The support wheel axle may be formed sufficiently stable to allow a stable support of the mobile manipulator and may be formed by a single stiff element or by multiple interconnected elements, which may, for instance, operate in a telescopic arm like manner. Also, more than one support wheel may be provided.

In a preferred embodiment, the control of the mobile manipulator includes the steps of controlling the mobile manipulator in accordance with one or more stabilization methods for adjusting the mobile manipulator during the movement and controlling the telescopic support arm and/or controlling the support wheels.

Thus, a combined approach for stabilizing the mobile manipulator may be provided. The further stabilization control methods may be based on the step of adjusting the center of mass of the mobile manipulator including an adjustment of the manipulator arm configuration and/or adjusting of variable mass elements of the mobile manipulator.

Or the further stabilization control methods may be based on the step of adjusting the mobile manipulator comprising a dynamic manipulator arm movement, which may be controlled by the following first control function:

$$f ( {ZMP}_{real} ( {\ddot{q}}_{M} , {\dot{q}}_{M} , {q}_{M} , t ) , {ZMP}_{d e s} ( t ) ) = min e$$

wherein “ZMP_{des}(t)” may be the desired ZMP trajectory; “ZMPᵣₑₐₗ” may be the real ZMP trajectory; “t” may be a time; “\ddot{q}_{M}, \dot{q}_{M}, q_{M},” may be joint states of acceleration, velocity and position of the manipulator arm; and “e” may be a deviation of the real ZMP trajectory from the desired ZMP trajectory.

Or the further stabilization control methods may be based on the step of adjusting the mobile manipulator based on the following second control or planning function:

$$\int f ( {ZMP}_{real} ( {\ddot{q}}_{M} , {\dot{q}}_{M} , {q}_{M} , t ) , {ZMP}_{d e s} ( t ) ) d s = min e$$

wherein the joint accelerations of the manipulator arm “\ddot{q}_{M}” may be preferably used as an input variable for the second control function.

Or the further stabilization control methods may be based on the step of adjusting the mobile manipulator comprising a dynamic manipulator arm movement, which may be controlled by the following first control function:

$$f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) = min e$$

wherein “q_{BR}, \dot{q}_{BR}, \ddot{q}_{BR}” may be a rotational position, rotational velocity and rotational acceleration of the manipulator base.

Or the further stabilization control methods may be based on the step of adjusting the mobile manipulator based on the following second control or planning function:

$$\int f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) d s = min e$$

Accordingly, one or more of the above noted stabilization control approaches may be applied, and, for instance in case the above noted approaches do not sufficiently provide a stable movement of the mobile manipulator, the telescopic support arm and/or the support wheels may be accordingly controlled to further stabilize the mobile manipulator.

In a preferred embodiment, the support wheel can be activated to extend from the manipulator base to contact the ground and to increase the support polygon of the mobile manipulator.

Thus, a flexible adjustment of the support polygon may be provided allowing for a respective control of the mobile manipulator to achieve stable movement. An activation may include an extension movement of the support wheel away from the manipulator base to increase the support surface or support polygon of the mobile manipulator. An activation may include an expansion of the support wheel axle, such that the contact of the support wheel with the ground may be suitably spaced apart from the manipulator base. Likewise, when it may be determined that no additional support is needed, the support wheel may be accordingly retracted again. The activation may include that the distance of the support wheel to the manipulator base, which is needed to stabilize the mobile manipulator, is determined and the support wheel may be accordingly controlled to extend to this distance and contact the ground.

In a preferred embodiment, the mobile manipulator comprises a plurality of support wheels, and a selected one of the plurality of support wheels is selected based on the following steps: applying one or more of the stabilization methods, determining if the real ZMP trajectory of the mobile manipulator corresponds to the desired ZMP trajectory considering the selected stabilization method, and, when the real ZMP trajectory of the mobile manipulator does not correspond to the desired ZMP trajectory, the method further comprises the steps of: determining at least one support wheel suitable to increase the support polygon such that the real ZMP trajectory of the mobile manipulator corresponds to the desired ZMP trajectory, activate the selected support wheel from the plurality of the support wheels.

Thus, a customized support for the mobile manipulator may be provided, which may use distinct support wheels from a plurality of support wheels. Accordingly, support wheels, which may not be suitable or less suitable than the selected support wheel, may not be activated. This may prevent an undue extension of the footprint of the mobile manipulator. The selection of a selected one of the support wheels may be based on spatial constraints of the environment of the mobile manipulator. Or the selection may be based on one or more optimization criteria, such as the requirement to increase the support polygon only until stable movement of the mobile manipulator is achieved. Also, more than one support wheel may be determined and activated.

In a preferred embodiment, the activation of the support wheel includes the step of determining and setting a distinct distance the support wheel extends from the manipulator base.

Hence, an unnecessary spacing of the support wheels may be prevented while a stable movement of the mobile manipulator may be achieved. The respective distance to be set may be determined and set by respective determination and control means of the mobile manipulator. This may include the determination of the extent of instability of the movable mobile manipulator based on the current and desired ZMP trajectories.

The invention further relates to a mobile manipulator, comprising a manipulator base, at least one manipulator arm, and a control means adapted to control the mobile manipulator in accordance with the method of the present disclosure.

Thus, a mobile manipulator may be provided, wherein the mobile manipulator may be accordingly controllable to achieve an increased stability. It is noted that the above explanations regarding certain elements or advantages described with respect to the method of controlling a mobile manipulator of the present disclosure accordingly apply to the mobile manipulator described herein. Thus, a mobile manipulator, which is particularly stable during the movement or at standstill may be provided. The control means may be arranged at the mobile manipulator or at least partially outside and remote to the mobile manipulator. The control means may comprise suitable computing and controlling means for controlling any elements of the mobile manipulator, for instance an orientation or extension of the manipulator arm, a propelling speed, acceleration or a steering of the wheels and/or an activation or deactivation of one or more external stabilizing devices. The control means may comprise respective sensors or detectors to determine a current position or movement of the respective elements. The determination of a configuration of the mobile manipulator and/or the determination or prediction of any parameters, such as the current configuration of the mobile manipulator, the desired movement trajectory, the determination of the ZMP, the current or desired ZMP trajectory and so forth, may be performed by respective computational means, which may or may not be part of control means of the mobile manipulator. The mobile manipulator may comprise one or more tools arranged at the distal end of the manipulator arm to perform respective manipulating actions, such as for instance picking and lifting an item and transporting and placing said item at a different position.

In a preferred embodiment, the manipulator base comprises at least one telescopic support arm, wherein the telescopic support arm is controllable in accordance with the method of the present disclosure.

In a preferred embodiment, the manipulator base comprises at least one support wheel, wherein the support wheel is controllable in accordance with the method of the present disclosure.

Thus, a particular stable mobile manipulator may be achieved, which may comprise at least one telescopic support arm and/or at least one support wheel.

In a preferred embodiment, the mobile manipulator is an autonomous mobile manipulation robot, preferably comprising more than two steerable wheels.

Thus, a flexible and reliably stabilizable autonomous mobile manipulation robot is provided. This may include any type of manipulation robot, such as a mobile manipulator which may be movable over the ground. The movement of the robot along the ground and the movement of the arm may be fully or semi-automatically controlled. At least more than two steerable wheels may allow for a particularly well controlled movement over the ground. The wheels may be jointly or independently propellable or steerable. The mobile manipulation robot may be an industrial robot, a logistic robot, a medical robot, a laboratory robot or any other kind of robot, working in a respective industrial, logistic, medical or laboratory environment, that may use one or more manipulation arms arranged on a movable manipulator base to execute the desired tasks.

The invention further relates to a computer-program product comprising instructions, which, when executed by a computer, cause the computer to carry out and/or control any of the methods of the present disclosure.

The features of the system according to the present invention may be implemented by respective suitable digital or computational means, which can include, for instance, one or more computers, apps and/or networks.

The method may be at least partly computer-implemented, and may be implemented in software or in hardware, or in software and hardware. Further, the method may be carried out by computer program instructions running on means that provide data processing functions.

The data processing means may be a suitable computing means, such as an electronic control module etc., which may also be a distributed computer system. The data processing means or the computer, respectively, may comprise one or more of a processor, a memory, a data interface, or the like.

The invention further relates to a computer-readable medium comprising instructions which, when executed by a computer, cause the computer to carry out and/or control any of the methods of the present disclosure.

Any of the computer, the computer-program product and/or the computer-readable medium may be at least part of the mobile manipulator or may be arranged remotely to the mobile manipulator.

The features and advantages outlined above in the context of the system and the method similarly apply to the computer program product and the computer-readable medium described herein. Likewise, any features and advantages noted with regard to the method of the present invention apply accordingly to the mobile manipulator of the present invention and vice versa.

A computer program may be stored/distributed on a suitable medium such as an optical storage medium or a solid-state medium, supplied together with or as part of other hardware, but may also be distributed in other forms, such as via the Internet or other wired or wireless telecommunication systems.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

1 mobile manipulator
3 manipulator base
5 manipulator arm
7 control means
9 contact elements
11 ground
13 mass element
15 tool center point
17 telescopic arm
19 support wheel
100 computer
200 computer program product
300 computer readable medium
S1 to S4 method steps

What is claimed is:

1. A method for controlling a mobile manipulator comprising a manipulator base and at least one manipulator arm, the method comprising:
determining a current configuration of the mobile manipulator including a manipulator arm configuration and a manipulator base configuration;
determining a desired movement trajectory of the mobile manipulator;
determining a current zero-movement points (ZMP) trajectory comprising the location of one or more current ZMP of the mobile manipulator based on the current configuration of the mobile manipulator and the desired movement trajectory;
determining a desired ZMP trajectory of the mobile manipulator, wherein each ZMP is located within a support polygon of the manipulator base; and
adjusting the mobile manipulator such that the current ZMP trajectory corresponds to the desired ZMP trajectory;
wherein the mobile manipulator further comprises at least one external stabilizing device and wherein the step of adjusting the mobile manipulator comprises the step of supporting of the mobile manipulator by the external stabilizing device.

2. The method according to claim 1, wherein the manipulator base comprises one or more contact elements configured to contact a ground upon which the mobile manipulator is movable, wherein the contact elements are formed by wheels.

3. The method according to claim 1, wherein the manipulator base comprises at least three contact elements, wherein the support polygon is defined by an area formed between the contact elements and, wherein, when the mobile manipulator is stabilized by the external stabilizing device, the support polygon is additionally defined by a contact point of the external stabilizing device, wherein the ZMP are adjusted to be located within the support polygon of the mobile manipulator.

4. The method according to claim 1, wherein the external stabilizing device comprises at least one telescopic support arm, which can be activated or deactivated based on the following steps:
determining the ZMP of the mobile manipulator during movement of the manipulator arm;
deactivating the telescopic support arm when the ZMP of the mobile manipulator is determined to be located in the support polygon; and
activating the telescopic support arm when the ZMP of the mobile manipulator is determined to be located outside in the support polygon.

5. The method according to claim 1, wherein the external stabilizing device comprises at least one support wheel, wherein the support wheel, which can be activated or deactivated, and wherein the support wheel, when activated, contacts the ground and increases the support polygon of the mobile manipulator.

6. The method according to claim 5, wherein the control of the mobile manipulator includes:
controlling the mobile manipulator in accordance with one or more stabilization methods for adjusting the mobile manipulator during the movement; and
controlling the telescopic support arm and/or controlling the support wheels.

7. The method according to claim 5, wherein the support wheel can be activated to extend from the manipulator base to contact the ground and to increase the support polygon of the mobile manipulator.

8. The method according to claim 1, wherein the mobile manipulator comprises a plurality of support wheels, and wherein a selected one of the plurality of support wheels is selected based on:
applying one or more of the stabilization methods;
determining whether the real ZMP trajectory of the mobile manipulator corresponds to the desired ZMP trajectory considering the selected stabilization method; and,
when the real ZMP trajectory of the mobile manipulator does not correspond to the desired ZMP trajectory, the method further comprises:
determining at least one support wheel suitable to increase the support polygon such that the real ZMP trajectory of the mobile manipulator corresponds to the desired ZMP trajectory, and
activating the selected support wheel from the plurality of the support wheels.

9. The method according to claim 8, wherein the activation of the support wheel includes determining and setting a distinct distance the support wheel extends from the manipulator base.

10. A mobile manipulator, comprising:
a manipulator base;
at least one manipulator arm;
at least one external stabilizing device; and
a control means adapted to control the mobile manipulator in accordance with a method comprising:
determining a current configuration of the mobile manipulator including a manipulator arm configuration and a manipulator base configuration;
determining a desired movement trajectory of the mobile manipulator;
determining a current zero-movement points (ZMP) trajectory comprising the location of one or more current ZMP of the mobile manipulator based on the current configuration of the mobile manipulator and the desired movement trajectory;
determining a desired ZMP trajectory of the mobile manipulator, wherein each ZMP is located within a support polygon of the manipulator base; and
adjusting the mobile manipulator such that the current ZMP trajectory corresponds to the desired ZMP trajectory;
wherein the mobile manipulator further comprises at least one external stabilizing device and wherein the step of adjusting the mobile manipulator comprises the step of supporting of the mobile manipulator by the external stabilizing device.

11. The mobile manipulator according to claim 10, wherein the manipulator base comprises at least one telescopic support arm.

12. The mobile manipulator according to claim 10, wherein the manipulator base comprises at least one support wheel, wherein the support wheel can be activated or deactivated, and wherein the support wheel, when activated, contacts the ground and increases the support polygon of the mobile manipulator.

13. The mobile manipulator according to claim 10, wherein the mobile manipulator is an autonomous mobile manipulation robot comprising more than two steerable wheels.

14. A computer-readable medium comprising instructions which, when executed by a computer, cause the computer to carry out a method, the instructions comprising:
instructions for determining a current configuration of the mobile manipulator including a manipulator arm configuration and a manipulator base configuration;
instructions for determining a desired movement trajectory of the mobile manipulator;
instructions for determining a current zero-movement points (ZMP) trajectory comprising the location of one or more current ZMP of the mobile manipulator based on the current configuration of the mobile manipulator and the desired movement trajectory;
instructions for determining a desired ZMP trajectory of the mobile manipulator, wherein each ZMP is located within a support polygon of the manipulator base; and
instructions for adjusting the mobile manipulator such that the current ZMP trajectory corresponds to the desired ZMP trajectory;
wherein the mobile manipulator further comprises at least one external stabilizing device and wherein the step of adjusting the mobile manipulator comprises the step of supporting of the mobile manipulator by the external stabilizing device.
